(19) United States
(12) Patent Application Publication
(10) Pub. No.: US 2025/0058600 A1
(43) Pub. Date: Feb. 20, 2025

(54) BUSHING DEVICE FOR STABILIZER

(71) Applicant: HYUNDAI MOBIS CO., LTD., Seoul (KR)

(72) Inventor: Jung Min KIM, Yongin-si (KR)

(73) Assignee: HYUNDAI MOBIS CO., LTD., Seoul (KR)

(21) Appl. No.: 18/624,462

(22) Filed: Apr. 2, 2024

(30) Foreign Application Priority Data
Aug. 16, 2023 (KR) 10-2023-0106907

(51) Int. Cl. B60G 21/055

(52) U.S. Cl. CPC B60G 21/0551; B60G 2202/135; B60G 2204/1224; B60G 2204/41

(57) ABSTRACT

A bushing device for a stabilizer includes a bracket section coupled to a subframe, a bearing section mounted on the bracket section, a bushing section coupled to the bearing section to surround a stabilizer bar, and a pair of foreign substance blocking sections respectively coupled to two ends of the bracket section so as to contact the stabilizer bar so that a gap between the stabilizer bar and the bracket section is removed to block foreign substances from entering the bracket section from an outside.

### CROSS-REFERENCE TO RELATED APPLICATION

This application claims priority from and the benefit of Korean Patent Application No. 10-2023-0106907, filed on Aug. 16, 2023, which is hereby incorporated by reference for all purposes as if set forth herein.

### BACKGROUND

### Field

Exemplary embodiments of the present disclosure relate to a bushing device for a stabilizer and, more particularly, to a bushing device for a stabilizer with which foreign substances are prevented from entering from an outside.

### Discussion of the Background

Typically, a vehicle is equipped with a stabilizer bar which acts as a kind of torsion bar to keep the turning vehicle in equilibrium by preventing occurrence of a phenomenon in which the vehicle is tilted to one side due to centrifugal force being generated and added to the vehicle body during vehicle turning.

The stabilizer bar is secured to the vehicle body by means of a bushing fastened to the vehicle body. The bushing serves to buffer and prevent the rotation impact and noise of the stabilizer bar. However, due to the gap between the stabilizer bar and the bushing, a problem arises in that foreign substances enter the interior of the bushing from the outside. Therefore, there is a need to solve this problem.

### SUMMARY

Various embodiments are directed to a bushing device for a stabilizer with which foreign substances are prevented from entering from the outside.

In an embodiment of the present disclosure, a bushing device for a stabilizer includes: a bracket section coupled to a subframe; a bearing section mounted on the bracket section; a bushing section coupled to the bearing section to surround a stabilizer bar; and a pair of foreign substance blocking sections respectively coupled to two ends of the bracket section so as to contact the stabilizer bar so that a gap between the stabilizer bar and the bracket section is removed to block foreign substances from entering the bracket section from the outside.

Each of the foreign substance blocking sections may include: a foreign substance blocking plate coupled to the bracket section to surround an outer portion of the stabilizer bar; and an engagement portion engaged with the foreign substance blocking plate and configured to compress the foreign substance blocking plate to allow the foreign substance blocking plate to contact the stabilizer bar.

The foreign substance blocking plate may include an elastic material.

The foreign substance blocking plate may include: a plate contact surrounding the outer portion of the stabilizer bar and elastically deformed by compression of the engagement portion to contact the stabilizer bar; a plate body bent and extending outwardly from an outer portion of the plate contact to cover the two ends of the bracket section; and a plate engagement protrusion protruding from the plate body toward a corresponding end of the bracket section to engage with the bracket section.

The plate contact may have a first engagement groove portion in which the engagement portion is engaged.

The bracket section may include: a lower bracket portion brought into contact with the bushing section and having an end to which the plate engagement protrusion is fastened; and an upper bracket portion connected to the lower bracket portion, coupled to the subframe, brought into contact with the bushing section, and having an end to which the plate engagement protrusion is fastened.

The bracket section may further include: a second engagement groove portion formed in any one of the lower bracket portion and the upper bracket portion; and an engagement protrusion portion formed in a remaining one of the lower bracket portion and the upper bracket portion to engage in the second engagement groove portion.

The lower bracket portion may further include: a lower bracket body having a first engagement groove in which the plate engagement protrusion engages, wherein any one of the second engagement groove portion and the engagement protrusion portion is formed on the lower bracket body; and a first blocking protrusion protruding inwardly from the lower bracket body and brought into contact with the bushing section, so as to block foreign substances from entering the bushing section by removing a gap with the bushing section.

The upper bracket portion may include: an upper bracket body slidably coupled to the lower bracket body and having a second engagement groove in which the plate engagement protrusion engages, in which a remaining one of the second engagement groove portion and the engagement protrusion portion is formed on the upper bracket body; and a second blocking protrusion protruding inwardly from the upper bracket body and brought into contact with the bushing section, so as to block foreign substances from entering the bushing section by removing the gap with the bushing section.

The bushing section may include: a bushing coupled to the bearing section and including an elastic material; and a reinforcing member internally coupled to the bushing to reinforce stiffness of the bushing.

The bushing device for a stabilizer according to the present disclosure has the effect of preventing damage to the bushing device for a stabilizer due to foreign substances entering the interior of the bracket section from the outside through the foreign substance blocking section.

In addition, the present disclosure has the effect of completely preventing damage to the bushing device for a stabilizer due to an inflow of foreign substances by double-blocking the inflow of foreign substances into the interior of the bushing section through the blocking section and the first and second blocking protrusions of the foreign substance bracket section.

### BRIEF DESCRIPTION OF THE DRAWINGS

FIG. 1 is a schematic view illustrating a bushing device for a stabilizer according to an embodiment of the present disclosure, coupled to a subframe.

FIG. 2 is a perspective view illustrating the bushing device for a stabilizer according to the embodiment of the present disclosure.

FIG. 3 is a cross-sectional perspective view illustrating the bushing device for a stabilizer according to the embodiment of the present disclosure.

FIG. 4 is an enlarged view illustrating a major part of FIG. 3.

FIG. 5 is a cross-sectional view illustrating the bushing device for a stabilizer according to the embodiment of the present disclosure.

FIG. 6 is an exploded perspective view illustrating the bushing device for a stabilizer according to the embodiment of the present disclosure.

FIG. 7 is an exploded perspective view illustrating the bushing device for a stabilizer according to the embodiment of the present disclosure, which is seen in a different direction.

### DETAILED DESCRIPTION OF THE ILLUSTRATED EMBODIMENTS

Hereinafter, an exemplary embodiment of a bushing device for a stabilizer will be described below with reference to the accompanying drawings.

In the description, the thickness of the lines or the size of the components illustrated in the drawings may be exaggerated for clarity and convenience of explanation. In addition, the terms to be described later are terms defined in consideration of functions in the present disclosure, which may vary according to the user or operator's intention or practices in the art. Therefore, definitions of these terms should be made based on the content throughout this specification.

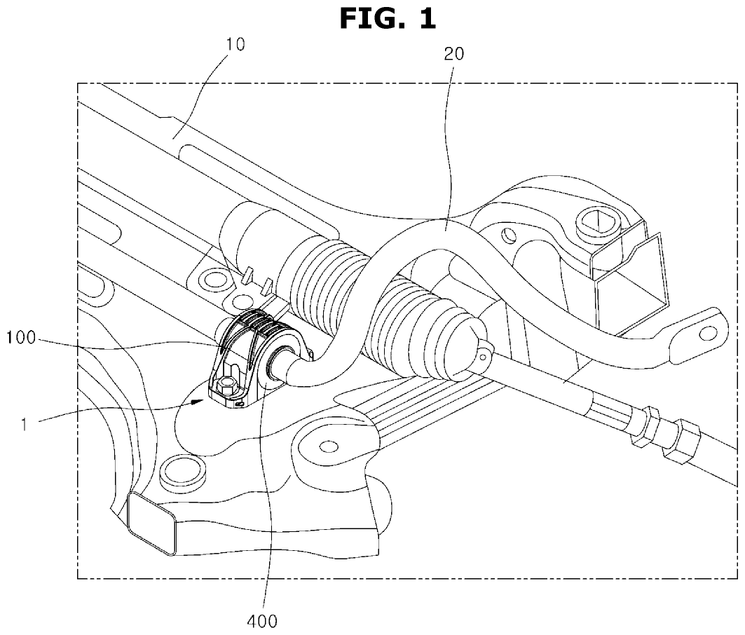

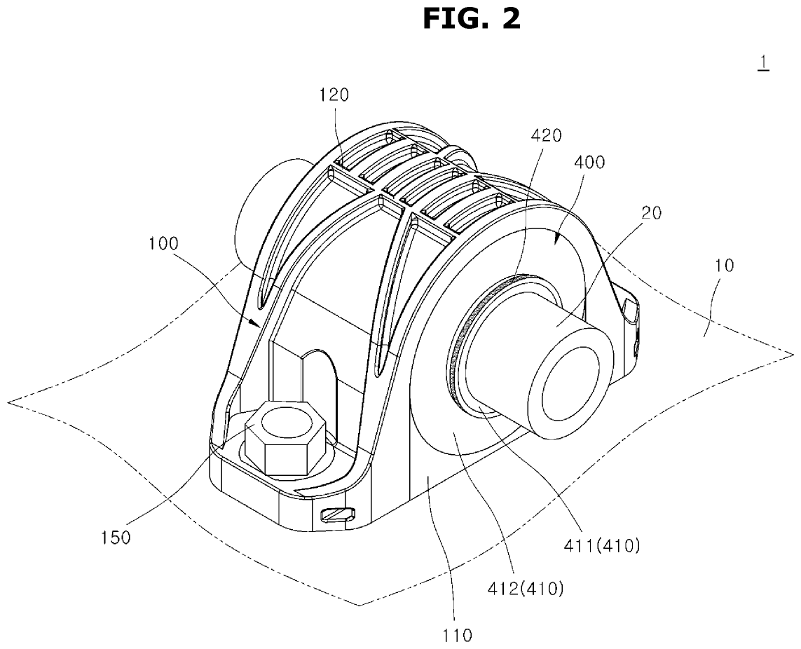

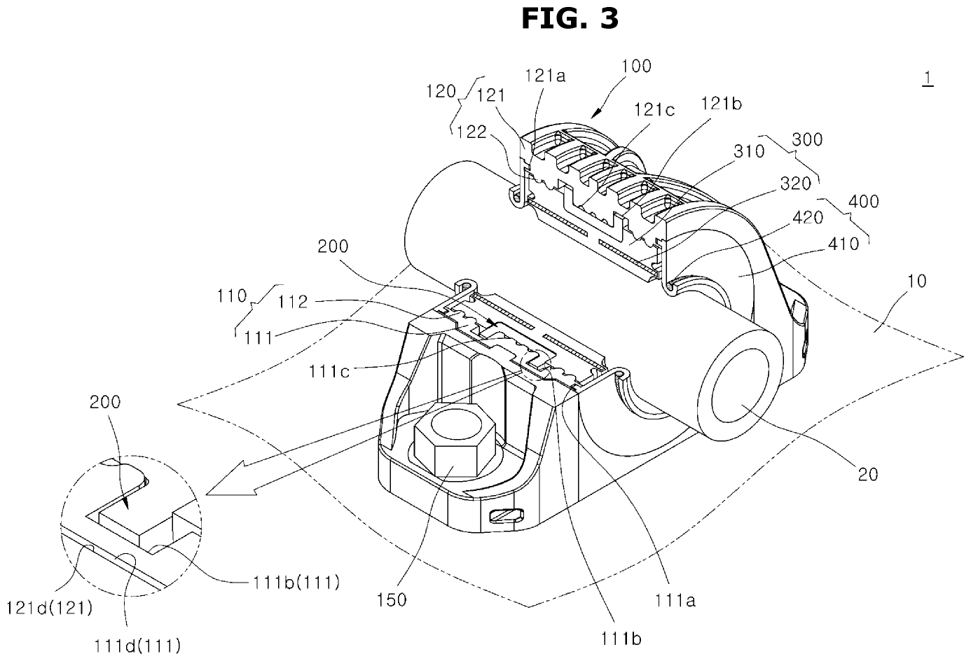

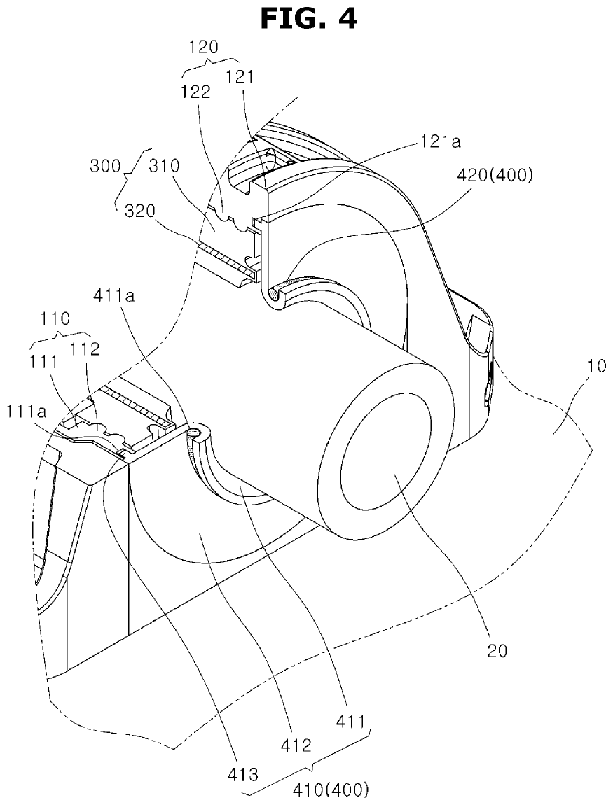

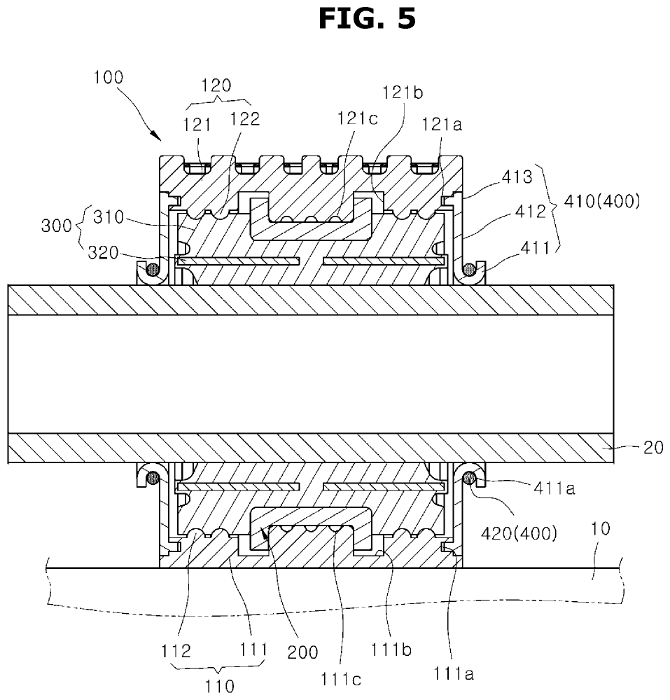

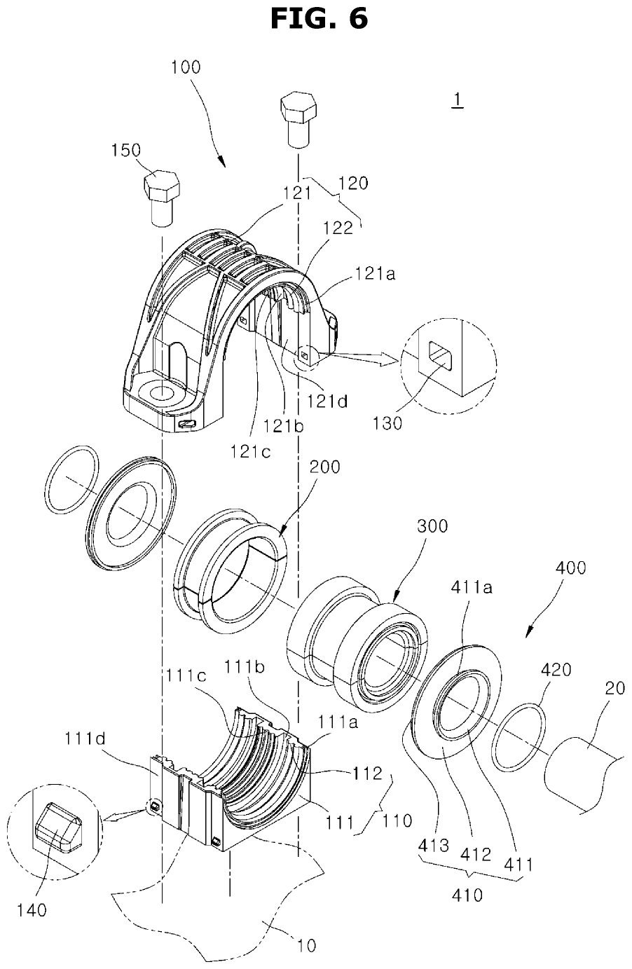

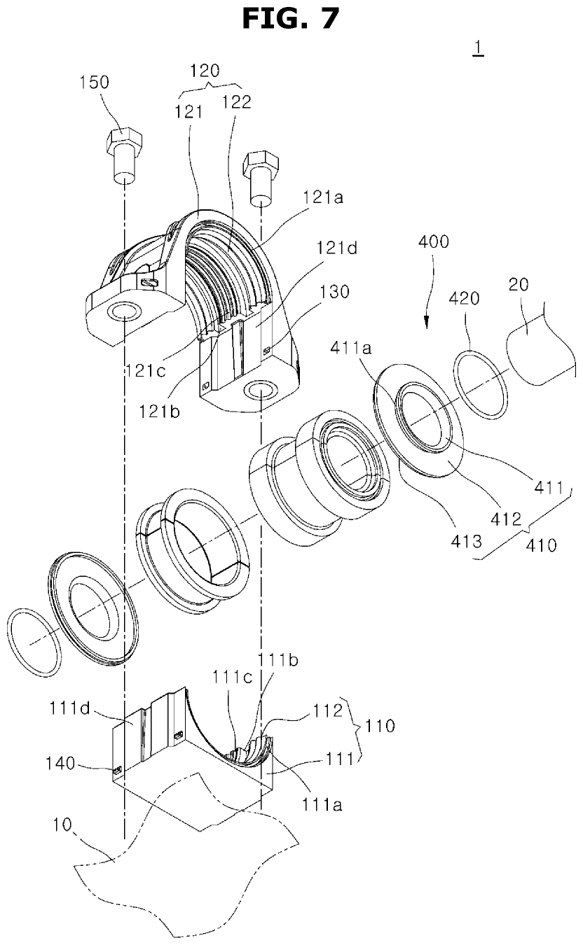

FIG. 1 is a schematic view illustrating a bushing device for a stabilizer according to an embodiment of the present disclosure, coupled to a subframe; FIG. 2 is a perspective view illustrating the bushing device for a stabilizer according to the embodiment of the present disclosure; FIG. 3 is a cross-sectional perspective view illustrating the bushing device for a stabilizer according to the embodiment of the present disclosure; FIG. 4 is an enlarged view illustrating a major part of FIG. 3; FIG. 5 is a cross-sectional view illustrating the bushing device for a stabilizer according to the embodiment of the present disclosure; FIG. 6 is an exploded perspective view illustrating the bushing device for a stabilizer according to the embodiment of the present disclosure; and FIG. 7 is an exploded perspective view illustrating the bushing device for a stabilizer according to the embodiment of the present disclosure, which is seen in a different direction.

Referring to FIGS. 1 to 7, the bushing device 1 for a stabilizer according to the embodiment of the present disclosure includes a bracket section 100, a bearing section 200, a bushing section 300, and a foreign substance blocking section 400. The bracket section 100 is coupled to a subframe 10. The subframe 10 is a part of alower vehicle body and is arranged to span across the wheels. A stabilizer bar 20 is positioned over an upper side of the subframe 10 (as illustrated in FIG. 1) and extends through the bracket section 100. The bracket section 100 is coupled to the subframe 10 (as illustrated in FIG. 1) via a bolt portion 150.

The bracket section 100 may include a lower bracket portion 110 and an upper bracket portion 120 (see FIGS. 2 to 5). The lower bracket portion 110 is brought into contact with the bushing section 300, and engages at both ends with a plate engagement protrusion 413 of the foreign substance blocking section 400.

The lower bracket portion 110 may include a lower bracket body 111 and a first blocking protrusion 112. The lower bracket body 111 has a first engagement groove 111a in which the plate engagement protrusion 413 engages, and on which any one of an engagement groove portion 130 and an engagement protrusion portion 140 described later is formed.

The lower bracket body 111 may further include a first mounting groove 111b in which the bearing section 200 is mounted, and a first lubrication groove 111c facing the bearing section 200 and through which lubricating oil flows.

Accordingly, a part of the bearing section 200 may be easily mounted on the lower bracket body 111, and the bearing section 200 may operate smoothly due to the lubricating oil flowing between the lower bracket body 111 and the bearing section 200.

The first blocking protrusion 112 is formed to protrude inwardly from the lower bracket body 111, contact the bushing section 300, and remove a gap with the bushing section 300, thereby preventing foreign substances from entering the bushing section 300. The plurality of first blocking protrusions 112 may be spaced apart at both ends of the lower bracket body 111.

As a result, if foreign substances enter the interior of the lower bracket portion 110 of the bracket section 100 due to damage to the foreign substance blocking section 400 or the like, the first blocking protrusions 112 may block the foreign substances from entering the interior of the bushing section 300. Accordingly, it is possible to prevent foreign substances from entering the interior of the bushing section 300 and damaging the bushing device 1 for a stabilizer.

The upper bracket portion 120 is connected to the lower bracket portion 110 and coupled to the subframe 10, and is brought into contact with the bushing section 300. The upper bracket portion 120 has both ends to which the plate engagement protrusion 413 of the foreign substance blocking section 400 is fastened. The upper bracket portion 120 is slidably coupled to the lower bracket portion 110 into a pre-fabricated state and is coupled to the subframe 10 by the bolt portion 150.

The upper bracket portion 120 may include an upper bracket body 121 and a second blocking protrusion 122. The upper bracket body 121 is slidably coupled to the bracket body 111 of the lower bracket portion and has a second engagement groove 121a in which the plate engagement protrusion 413 engages and a remaining one of the engagement groove portion 130 and the engagement protrusion portion 140 is formed on the upper bracket body 121.

The upper bracket body 121 may further include a second mounting groove 121b in which the bearing section 200 is mounted, and a second lubrication groove 121c facing the bearing section 200 and through which lubricating oil flows.

Accordingly, the bearing section 200 may be easily mounted on the upper bracket body 121 on the other side, and the bearing section 200 may operate smoothly due to the lubricating oil flowing between the upper bracket body 121 and the bearing section 200.

The second blocking protrusion 122 is formed to protrude inwardly from the upper bracket body 121, contact the bushing section 300, and remove the gap with the bushing section 300, thereby blocking foreign substances from entering the bushing section 300.

As a result, if foreign substances enter the interior of the upper bracket portion 120 of the bracket section 100 due to damage to the foreign substance blocking section 400 or the like, the second blocking protrusions 122 may block the foreign substances from entering the interior of the bushing section 300. Accordingly, it is possible to prevent foreign substances from entering the interior of the bushing section 300 and damaging the bushing device 1 for a stabilizer.

The bracket section 100 may further include an engagement groove portion 130 and an engagement protrusion portion 140 (see FIGS. 6 and 7). The engagement groove portion 130 is formed in any one of the lower bracket portion 110 and the upper bracket portion 120.

The engagement protrusion portion 140 is formed on a remaining one of the lower bracket portion 110 and the upper bracket portion 120 and engages in the engagement groove portion 130.

Specifically, the engagement groove portion 130 may be formed on the upper bracket body 121 of the upper bracket portion 120. In this case, the engagement groove portion 130 may be formed in a first engagement portion 121d of the upper bracket body 121 of the upper bracket portion.

The engagement protrusion portion 140 may be formed to protrude from the lower bracket body 111 of the lower bracket portion 110. The engagement protrusion portion 140 may be formed to protrude from a second engagement portion 111d of the lower bracket body 111 of the lower bracket portion slidably engaged with the first engagement portion 121d of the upper bracket body 121 of the upper bracket portion.

As a result, the engagement protrusion portion 140 is engaged in the engagement groove portion 130 when the first engagement portion 121d and the second engagement portion 111d are slidingly engaged.

In this way, as the lower bracket portion 110 and the upper bracket portion 120 are engaged together, it is possible to prevent the upper bracket portion 120 from being disengaged from the lower bracket portion 110.

Furthermore, in a pre-fabricated state of the lower bracket portion 110 and the upper bracket portion 120, the upper bracket portion 120 may be easily coupled to the subframe 10, which may improve assembly efficiency.

The bracket section 100 may further include a bolt portion 150. The bolt portion 150 may bolt the upper bracket portion 120 to the subframe 10. As a result, the bracket section 100 may be firmly coupled to the subframe 10.

The bearing section 200 is mounted on the bracket section 100. The bearing section 200 is disposed between the lower bracket portion 110 of the bracket section 100and the bushing section 300, and between the upper bracket portion 120 and the bushing section 300, and serves to facilitate rotation of the bushing section 300 engaged with the stabilizer bar 20.

The bushing section 300 is coupled to the bearing section 200 and surrounds the stabilizer bar 20. Here, the bushing section 300 is coupled such that the stabilizer bar 20 passes through the center of the bushing section.

The bushing section 300 may include a bushing 310 and a reinforcing member 320. The bushing 310 is coupled to the bearing section 200 and is formed of an elastic material. The bushing 310 may be formed of a rubber material and may be elastically deformed upon rotation of the stabilizer bar 20.

The reinforcing member 320 is internally coupled to the bushing 310 and provides stiffness to the bushing 310. The reinforcing member 320 is integrally combined inside the bushing 310 as heavy iron to support the bushing 310. This allows the bushing 310 to maintain a constant shape.

The foreign substance blocking sections 400 are respectively coupled to both ends of the bracket section 100, contact the stabilizer bar 20, and remove a gap between the stabilizer bar 20 and the bracket section 100 to block foreign substances from entering the bracket section 100 from the outside (see FIGS. 3 to 7).

The foreign substance blocking sections 400 cover openings (not shown) provided at both ends of the bracket section 100, and eliminate the gap between the stabilizer bar 20 and the bracket section 100 to block foreign substances from entering the interior of the bracket section 100 from the outside.

The foreign substance blocking section 400 may include a blocking plate 410 and an engagement portion 420. The blocking plate 410 is coupled to the bracket section 100 and surrounds an outer portion of the stabilizer bar 20.

The blocking plate 410 is formed of an elastic material and is elastically deformed upon engagement of the engagement portion 420 to contact the outer perimeter of the stabilizer bar 20. As a result, the gap between the stabilizer bar 20 and the bracket section 100 may be eliminated, thereby preventing foreign substances from entering the interior of the bracket section 100 from the outside.

The blocking plate 410 may include a plate contact 411, a plate body 412, and a plate engagement protrusion 413.

The plate contact 411 surrounds the outer periphery of the stabilizer bar 20 and is elastically deformed due to compression of the engagement portion 420 to contact the stabilizer bar 20.

The plate contact 411 includes an engagement groove portion 411a in which the engagement portion 420 engages. This allows the engagement portion 420 to be reliably engaged in the engagement groove portion 411a, and also prevents the engagement portion 420 from being disengaged out of the plate contact 411.

When the engagement portion 420 is engaged in the engagement groove portion 411a, the plate contact 411 is elastically deformed due to compression of the engagement portion 420 and contacts the stabilizer bar 20. As a result, the gap between the stabilizer bar 20 and the bracket section 100 may be eliminated, thereby preventing foreign substances from entering the interior of the bracket section 100 from the outside.

The plate body 412 of the foreign substance blocking plate is bent and extends toward one side from an outer portion of the plate contact 411 so as to cover both ends of the bracket section 100.

The body body 412 of the foreign substance blocking plate is a ring-shaped plate that covers the openings provided at both ends of the lower bracket portion 110 and the upper bracket portion 120 of the bracket section 100, and is elastically deformable. Thus, the plate contact 411 and the stabilizer bar 20 may be easily brought into contact with each other, and the stabilizer bar 20 may be freely rotated.

The plate engagement protrusion 413 protrudes toward one side from the plate body 412 of the foreign substance blocking plate and engages with the bracket section 100.

The plate engagement protrusion 413 is formed as a ring-shaped portion to protrude toward one side from the plate body 412 of the foreign substance blocking plate, and engages in the first engagement groove 111a provided in the lower bracket portion 110 of the bracket section 100 and the second engagement groove 121a provided in the upper bracket portion 120 of the bracket section 100.

The engagement portion 420 compressively engages with the blocking plate 410to allow the blocking plate 410 to contact the stabilizer bar 20. At this time, the engagement portion 420 engages in the engagement groove portion 411a of the plate contact 411.

The engagement portion 420 may be a cable tie, which is length-adjustable to tighten against the plate contact 411 of the blocking plate 410. Accordingly, the plate contact 411 may be compressed by the tightening force of the engagement portion 420 and contact the stabilizer bar 20. As a result, the gap between the plate contact 411 of the blocking plate 410 and the stabilizer bar 20 may be eliminated.

In this case, the engagement portion 420 is not limited to the cable tie, but may be varied to the extent that it may compress the plate contact 411 of the blocking plate 410 and contact the stabilizer bar 20.

As described above, the bushing device 1 for a stabilizer according to the present disclosure may prevent damage to the bushing device 1 for a stabilizer due to an inflow of foreign substances by preventing the inflow of foreign substances into the bracket section 100 from the outside through the foreign substance blocking section 400.

In addition, the present disclosure may completely prevent damage to the bushing device for a stabilizer due to an inflow of foreign substances by employing a double-blocking structure simultaneously allowing a primary inflow of external foreign substances into the bracket section 100 through the foreign substance blocking section 400 and a secondary inflow of the foreign substances in the bracket section 100 into the bushing section 300 through the first and second blocking protrusions 112 and 122 of the bracket section 100.

Although exemplary embodiments of the disclosure have been disclosed for illustrative purposes, those skilled in the art will appreciate that various modifications and equivalents are possible from the embodiments. Therefore, the true technical scope of the disclosure should be defined by the following claims.

What is claimed is:

1. A bushing device for a stabilizer, comprising:
a bracket section coupled to a subframe;
a bearing section mounted on the bracket section;
a bushing section coupled to the bearing section to surround a stabilizer bar; and
a pair of foreign substance blocking sections respectively coupled to two ends of the bracket section so as to contact the stabilizer bar so that a gap between the stabilizer bar and the bracket section is removed to block foreign substances from entering the bracket section from an outside.

2. The bushing device according to claim 1, wherein each of the foreign substance blocking sections comprises:
a foreign substance blocking plate coupled to the bracket section to surround an outer portion of the stabilizer bar; and
an engagement portion engaged with the foreign substance blocking plate and configured to compress the foreign substance blocking plate to allow the foreign substance blocking plate to contact the stabilizer bar.

3. The bushing device according to claim 2, wherein the foreign substance blocking plate includes an elastic material.

4. The bushing device according to claim 3, wherein the foreign substance blocking plate comprises:
a plate contact surrounding the outer portion of the stabilizer bar and elastically deformed by compression of the engagement portion to contact the stabilizer bar;
a plate body bent and extending outwardly from an outer portion of the plate contact to cover the two ends of the bracket section; and
a plate engagement protrusion protruding from the plate body toward a corresponding end of the bracket section to engage with the bracket section.

5. The bushing device according to claim 4, wherein the plate contact has a first engagement groove portion in which the engagement portion is engaged.

6. The bushing device according to claim 4, wherein the bracket section comprises:
a lower bracket portion brought into contact with the bushing section and having an end to which the plate engagement protrusion is fastened; and
an upper bracket portion connected to the lower bracket portion, coupled to the subframe, brought into contact with the bushing section, and having an end to which the plate engagement protrusion is fastened.

7. The bushing device according to claim 6, wherein the bracket section further comprises:
a second engagement groove portion formed in any one of the lower bracket portion and the upper bracket portion; and
an engagement protrusion portion formed in a remaining one of the lower bracket portion and the upper bracket portion to engage in the second engagement groove portion.

8. The bushing device according to claim 7, wherein the lower bracket portion further comprises:
a lower bracket body having a first engagement groove in which the plate engagement protrusion engages, wherein any one of the second engagement groove portion and the engagement protrusion portion is formed on the lower bracket body; and
a first blocking protrusion protruding inwardly from the lower bracket body and brought into contact with the bushing section, so as to block foreign substances from entering the bushing section by removing a gap with the bushing section.

9. The bushing device according to claim 8, wherein the upper bracket portion comprises:
an upper bracket body slidably coupled to the lower bracket body and having a second engagement groove in which the plate engagement protrusion engages, wherein a remaining one of the second engagement groove portion and the engagement protrusion portion is formed on the upper bracket body; and
a second blocking protrusion protruding inwardly from the upper bracket body and brought into contact with the bushing section, so as to block foreign substances from entering the bushing section by removing the gap with the bushing section.

10. The bushing device according to claim 1, wherein the bushing section comprises:
a bushing coupled to the bearing section and including an elastic material; and
a reinforcing member internally coupled to the bushing to reinforce stiffness of the bushing.
